(19) United States
(12) Patent Application Publication
(10) Pub. No.: US 2021/0026888 A1
(43) Pub. Date: Jan. 28, 2021

(54) VISUALIZATION OF A QUERY RESULT OF TIME SERIES DATA

(71) Applicant: VMware, Inc., Palo Alto, CA (US)

(72) Inventor: Clement PANG, Sunnyvale, CA (US)

(73) Assignee: VMware, Inc., Palo Alto, CA (US)

(21) Appl. No.: 16/704,482

(22) Filed: Dec. 5, 2019

Related U.S. Application Data
(60) Provisional application No. 62/879,075, filed on Jul. 26, 2019.

(51) Int. Cl. G06F 16/904; G06F 16/903; G06F 16/25

(52) U.S. Cl. CPC G06F 16/904; G06F 16/258; G06F 16/903

(57) ABSTRACT

In a computer-implemented method for visualization of a query result of time series data, a query of a time series database is received, where the query includes a time range, a predicate including at least one dimension, and a visualization view for displaying query results. The query is executed against the time series database to generate the query results according to an atom. Provided the atom does not correspond to the visualization view of the query, the query results are automatically converted according to the visualization view. The query results are displayed according to the visualization view of the query.

### RELATED APPLICATIONS

This application claims priority to and the benefit of co-pending U.S. Patent Provisional Patent Application 62/879,075, filed on Jul. 26, 2019, entitled “VISUALIZATION OF A QUERY RESULT OF TIME SERIES DATA,” by Clement Pang, having Attorney Docket No. F386.05.PRO, and assigned to the assignee of the present application, which is incorporated herein by reference in its entirety.

### BACKGROUND

Management, monitoring, and troubleshooting in dynamic environments, both cloud-based and on-premises products, is increasingly important as the popularity of such products continues to grow. As the quantities of time-sensitive data grow, conventional techniques are increasingly deficient in the management of these applications. Conventional techniques, such as relational databases, have difficulty managing large quantities of data and have limited scalability. Moreover, as monitoring analytics of these large quantities of data often have real-time requirements, the deficiencies of reliance on relational databases become more pronounced.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 is a block diagram illustrating a system for adapting time series database schema, in accordance with embodiments.

FIG. 2 is a block diagram illustrating an example query node, in accordance with embodiments.

FIG. 3 is a black diagram illustrating an example visualizer of a query node for displaying query results, in accordance with embodiments.

FIGS. 4A-4G depict example screenshots of various visualizations, in accordance with embodiments.

FIG. 5 is a block diagram of an example computer system upon which embodiments of the present invention can be implemented.

FIG. 6 depicts a flow diagram for visualization of a query result of time series data, according to various embodiments.

FIGS. 7A-7L depict flow diagrams of example operations for automatically converted according to the visualization view of the query, according to various embodiments.

### DETAILED DESCRIPTION OF CERTAIN EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments. As denoted elsewhere herein, like element numbers are intended to indicate like elements or features.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “receiving,” “executing,” “converting,” “displaying,” “generating,” “allocating,” “designating,” or the like, refer to the actions and processes of an electronic computing device or system such as: a host processor, a processor, a memory, a cloud-computing environment, a hyper-converged appliance, a software defined network (SDN) manager, a system manager, a virtualization management server or a virtual machine (VM), among others, of a virtualization infrastructure or a computer system of a distributed computing system, or the like, or a combination thereof. The electronic device manipulates and transforms data represented as physical (electronic and/or magnetic) quantities within the electronic device's registers and memories into other data similarly represented as physical quantities within the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example mobile electronic device described herein may include components other than those shown, including well-known components.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### OVERVIEW OF DISCUSSION

Example embodiments described herein improve the performance of computer systems by providing visualization of query results of time series data by automatically converting the data type of the query results to allow for different visualizations. Embodiments described herein provide time series data in accordance with particular fundamental units, also referred to herein as atoms. In some embodiments, the system for visualization of a query result of time series data provides four atoms of time series data: metrics, histograms, events, and spans.

In conventional systems for monitoring time series data, certain visualizations are available to certain atoms. For example, in conventional systems, the visualization for the metrics atom is a time series view, the visualization for the histogram atom is a histogram view, the visualization for the events atom is an events view, and the visualization for the spans atom is a spans view. Embodiments described herein provide for the automatic conversion of atoms during a query operation, allowing extensive additional visualizations.

Embodiments described herein provide methods and systems for visualization of a query result of time series data. A query of a time series database is received, where the query includes a time range, a predicate including at least one dimension, and a visualization view for displaying query results. The query is executed against the time series database to generate the query results according to an atom. Provided the atom does not correspond to the visualization view of the query, the query results are automatically converted according to the visualization view. In some embodiments, synthetic data based on the query results and the visualization view is generated, where the synthetic data is used for displaying the query results according to the visualization view. The query results are displayed according to the visualization view of the query.

In accordance with the described embodiments, the system for visualization of a query result of time series data provides four atoms: metrics, histograms, events, and spans, and four visualization views: time series views (e.g., line charts, point plots, scatter plots, table views, sparklines, etc.) histogram views (e.g., heatmaps, bar charts, histograms, etc.), events (e.g., a timeline, a list of events, etc.), and spans (e.g., trace waterfall views, etc.) The described embodiments provide for the conversion between these atoms synthetically by converting the underlying data and generating synthetic data, where necessary, to provide the requested view. For instance, a histogram view can be generated synthetically from metrics data, wherein synthetic data is generated based on the raw data to simulate the histogram view.

Hence, the embodiments of the present invention greatly extend beyond conventional methods of visualizing query results of time series data. For instance, automatic conversion of an underlying atom to a visualization view improves the performance of querying of the data by providing the generation of synthetic data based on a visualization view of a query. For instance, upon query, the query results can be provided in a view associated with a different data type than the underlying data, allowing for enhanced querying. Accordingly, embodiments of the present invention amount to significantly more than merely using a computer to visualize query results to time series data. Instead, embodiments of the present invention specifically recite a novel process, rooted in computer technology, for automatically converting query results to a different atom, improving performance of query processing in a time series data monitoring system.

### Example System for Visualization of a Query Result of Time Series Data

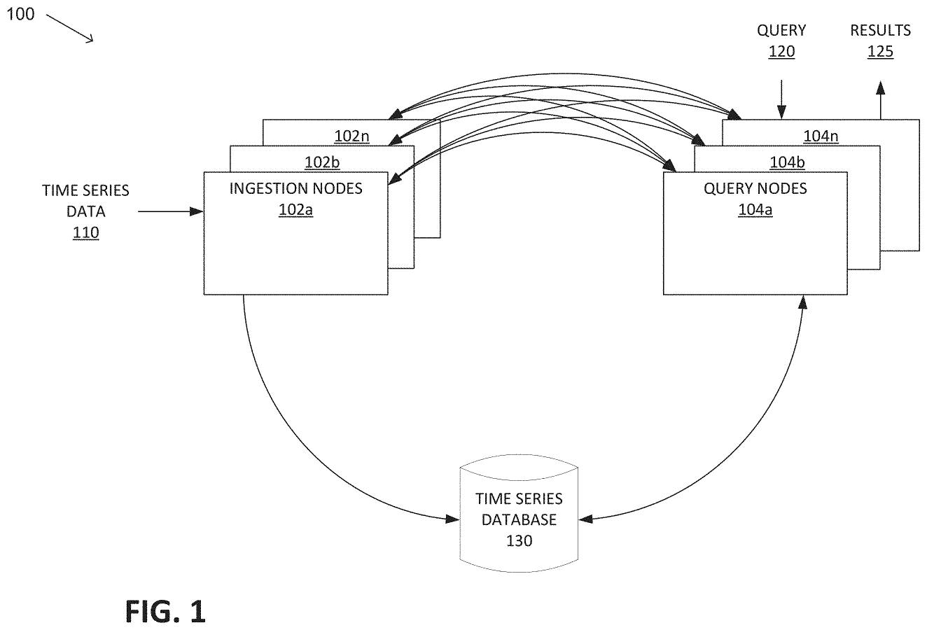

FIG. 1 is a block diagram illustrating an embodiment of a system 100 for adapting time series database schema of time series database 130, according to embodiments. System 100 is a distributed system including multiple ingestion nodes 102a through 102n (collectively referred to herein as ingestion nodes 102) and multiple query nodes 104a through 104n (collectively referred to herein as query nodes 104). Time series 110 is received at ingestion nodes 102 and stored within time series database 130. Query nodes 104 receive at least one query 120 for querying against time series database 130. Results 125 of query 120 are returned upon execution of query 120.

It should be appreciated that system 100 can include any number of ingestion nodes 102 and multiple query nodes 104. Ingestion nodes 102 and query nodes 104 can be distributed over a network of computing devices in many different configurations. For example, the respective ingestion nodes 102 and query nodes 104 can be implemented where individual nodes independently operate and perform separate ingestion or query operations. In some embodiments, multiple nodes may operate on a particular computing device (e.g., via virtualization), while performing independently of other nodes on the computing device. In other embodiment, many copies of the service (e.g., ingestion or query) are distributed across multiple nodes (e.g., for purposes of reliability and scalability).

Time series data 110 is received at at least one ingestion node 102a through 102n. In some embodiments, time series data includes a numerical measurement of a system or activity that can be collected and stored as a metric (also referred to as a “stream”). For example, one type of metric is a CPU load measured over time. Other examples include, service uptime, memory usage, etc. It should be appreciated that metrics can be collected for any type of measurable performance of a system or activity. Operations can be performed on data points in a stream. In some instances, the operations can be performed in real time as data points are received. In other instances, the operations can be performed on historical data. Metrics analysis include a variety of use cases including online services (e.g., access to applications), software development, energy, Internet of Things (IoT), financial services (e.g., payment processing), healthcare, manufacturing, retail, operations management, and the like. It should be appreciated that the preceding examples are non-limiting, and that metrics analysis can be utilized in many different types of use cases and applications.

In accordance with some embodiments, a data point in a stream (e.g., in a metric) includes a name, a source, a value, and a time stamp. Optionally, a data point can include one or more tags (e.g., point tags). For example, a data point for a metric may include:
A name—the name of the metric (e.g., CPU_idle, service.uptime)
A source—the name of an application, host, container, instance, or other entity generating the metric (e.g., web_server_1, app1, app2)
A value—the value of the metric (e.g., 99% idle, 1000, 2000)
A timestamp—the timestamp of the metric (e.g., 1418436586000)
One or more point tags (optional)—custom metadata associated with the metric (e.g., location=las_vegas, environment=prod)

Ingestion nodes 102 are configured to process received data points of time series data 110 for persistence and indexing. In some embodiments, ingestion nodes 102 forward the data points of time series data 110 to time series database 130 for storage. In some embodiments, the data points of time series data 110 are transmitted to an intermediate buffer for handling the storage of the data points at time series database 130. In one embodiment, time series database 130 can store and output time series data, e.g., TS1, TS2, TS3, etc. The data can include times series data, which may be discrete or continuous. For example, the data can include live data fed to a discrete stream, e.g., for a standing query. Continuous sources can include analog output representing a value as a function of time. With respect to processing operations, continuous data may be time sensitive, e.g., reacting to a declared time at which a unit of stream processing is attempted, or a constant, e.g., a 10V signal. Discrete streams can be provided to the processing operations in timestamp order. It should be appreciated that the time series data may be queried in real-time (e.g., by accessing the live data stream) or offline processing (e.g., by accessing the stored time series data).

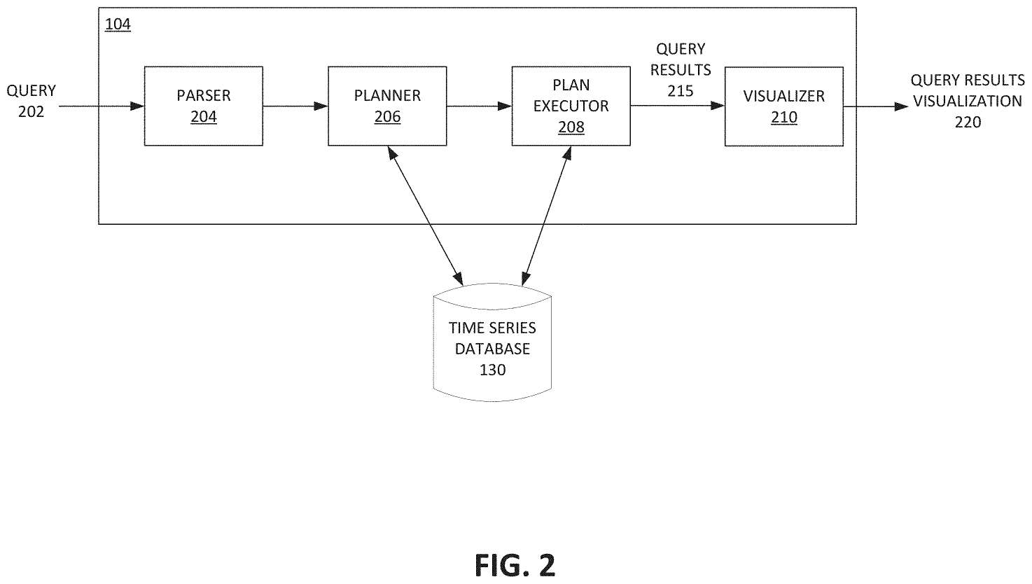

FIG. 2 is a block diagram illustrating an embodiment of example query node 104 (e.g., one of query nodes 104a through 104n of FIG. 1), according to embodiments. In one embodiment, query node 104 generates a query plan for the time series data based on the query 202. Query node 104 includes a parser 204, a planner 206, an executor 208, and a visualizer 210. Query node 104 can be implemented by a query execution engine configured to parse a query at parser 204, produce a query execution plan at planner 206, fetch time series data and run the time series data through processing operations, and determine an answer or response to the query at executor 208.

In the example shown in FIG. 2, a query 202 is received. In one embodiment, the query 202 is provided by a user via a client. Time series data is provided by time series database 130. The data can include times series data, which may be discrete or continuous. Query 202 is received for searching the time series data. A query can include elements that define searchable parameters of the time series data. For example, the query can include elements defining terms related to metrics, sources, values, timestamps, and/or point tags for isolating and returning relevant results. The parser 204 receives a query 202 and parses the query for a predicate (e.g., elements and operators). The predicate forms at least part of a basis for generating a query plan. For instance, consider the example query:
ts(“*graf*”, host=“*2*” and tag=app and (status=production or role=app) and cluster=mon and cpu=cpu-total)

The example query is parsed into the predicate including the elements and operators:
metric=“*graf*” AND
host=“*2*” AND
(status=production OR role=app) AND
cluster=mon AND
cpu=cpu-total

The planner 206 receives the parsed elements and operators of query 202 and generates a query plan for retrieval of relevant time series data that resolves the query 202. The planner 206 determines operations to be performed on the relevant time series data to retrieve a result of the query 202.

In operation, planner 206 receives a query. Planner 206 generates a query plan for determining what to retrieve from time series databases 130 based on the query. For example, planner 206 determines how many scans to make on the time series database(s). The planner 206 then hands off commands (e.g., a query plan) to executor 208 to perform an execution phase, e.g., beginning execution of the query 202. The executor 208 then outputs query results 215. Although shown as a single stream, the answer to the query results 215 can include one or more streams.

The executor 208 handles an “execution phase” in which operations are performed on time series data to generate an answer to the query. In various embodiments, the executor 208 executes a query plan from planner 206 and performs operations on the time series data based on the query plan, where the query plan includes a path of execution for resolving query 202. For example, one or more executors can perform the operation on the time series data concurrently. In various embodiments, the executor 208 responds to a query about the time series data and outputs query results 215. Although shown as separate components in FIG. 2, the planner 206 and the executor 208 can be implemented as a single component. The techniques described herein can be performed by the planner 206 and/or the executor 208.

The visualizer 210 is configured to receive query results 215 and generate a query results visualization 220 based on the query results 215. Query 202 includes a visualization view for displaying query results 215 according to a particular atom. System 100 provides time series data in accordance with particular fundamental units, also referred to herein as atoms. In some embodiments, system 100 provides four atoms of time series data: metrics, histograms, events, and spans. Metrics are data points that measure the same thing over time and are typically used for gaining a real-time and historical understanding of system health and trends. System 100 manages and monitors time series data, where the time series data includes numeric data points for a metric, for example, CPU load or failed network connections. Histograms are distributions of metrics rather than single metrics. Histograms are used for high-velocity metrics about applications and infrastructure, e.g., those gathered across many distributed sources. Events are records of something of interest that has happened. For example, the event might show that an alert has changed state. A span is a named, timed representation of a contiguous segment of work in a trace. Every span corresponds to a unique invocation of an operation in an instrumented application, and belongs to exactly one trace. Spans are the fundamental units of a trace, where a trace follows and examines a workflow or transaction in an application.

Visualizer 210 is configured to determine the atom of the query results (e.g., how the query results 215 are returned), and to automatically convert query results 215 for visualization as a different atom indicated by query 202. Any underlying atom of query results 215 can automatically be converted into another atom, e.g., a visualization view, by visualizer 210. For example, where a metrics query includes a histogram view, visualizer 210 converts the metrics of query results 215 into a histogram atom (e.g., by bucketing the metrics according to pre-set intervals) and presents a histogram view as query results visualization 220. Visualizer 210 adapts query results 215, e.g., by generating synthetic data, according to an intended output atom.

Although shown as separate components in FIG. 2, the executor 208 and the visualizer 210 or the planner 206, the executor 208, and the visualizer 210 can be implemented as a single component. The techniques described herein can be performed by the executor 208 and/or the visualizer 210.

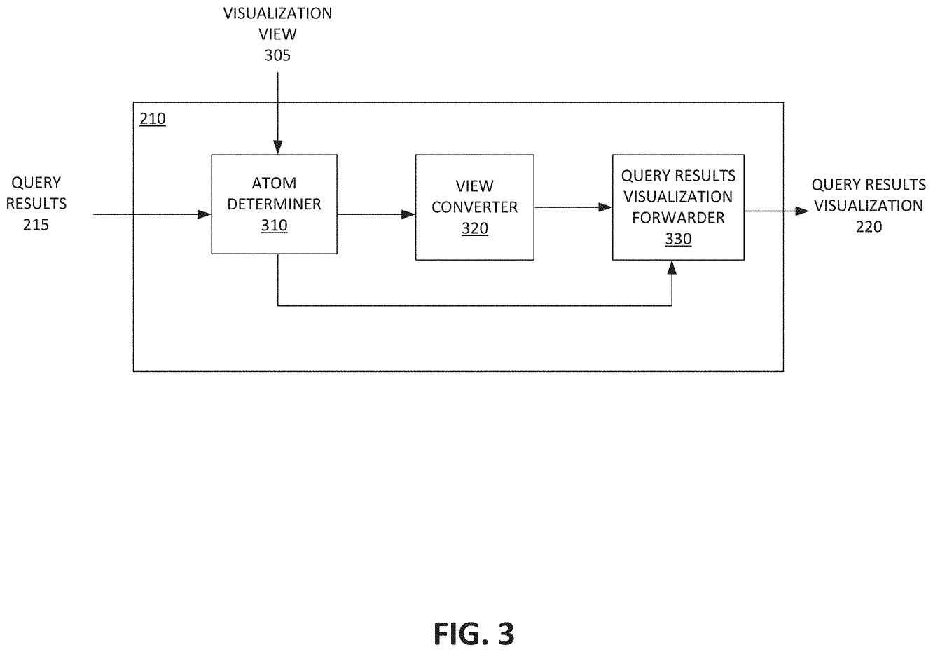

FIG. 3 is a black diagram illustrating an example visualizer 210 of a query node 104 (e.g., one of query nodes 104a through 104n of FIG. 1) for displaying query results, in accordance with embodiments. Query results 215 and visualization view 305 are received at atom determiner 310. Visualization view 305 is a component of query 202, and can be received at atom determiner 310 as a query 202, or can be extracted from query 202 (e.g., at parser 204) and communicated directly to atom determiner 310. It should be appreciated that atom determiner 310 is configured to determine the atom of query results 215 and the atom of visualization view 305. In some embodiments, if atom determiner 310 determines that the atom of query results 215 and the atom of visualization view 305 are the same, atom determiner 310 forwards query results 215 to query results visualization forwarder 330.

In some embodiments, if atom determiner 310 determines that the atom of query results 215 and the atom of visualization view 305 are not the same, query results 215 are converted into the atom of visualization view 305 at view converter 320.

View converter 320 is configured to automatically convert the atom of query results 215 to the atom of visualization view 305 prior to displaying query results 215. In accordance with the described embodiments, system 100 provides four atoms: metrics, histograms, events, and spans, and four visualization views: time series views (e.g., line charts, point plots, scatter plots, table views, sparklines, etc.) histogram views (e.g., heatmaps, bar charts, histograms, etc.), events (e.g., a timeline, a list of events, etc.), and spans (e.g., trace waterfall views, etc.) The described embodiments provide for the conversion between these atoms synthetically by converting the underlying data and generating synthetic data, where necessary, to provide the requested view. For instance, a histogram view can be generated synthetically from metrics data, wherein synthetic data is generated based on the raw data to simulate the histogram view. It should be appreciated that embodiments described herein may provide any number of atoms, and is not intended to be limited to the described examples.

The default view for metrics is time series data. In some embodiments, metrics are converted to a histogram view by generating buckets at pre-set intervals (e.g., one minute, one hour, one day, etc.) and placing the metrics data in the appropriate bucket for visualization. In some embodiments, the visualization view 305 can specify between various histogram views (e.g., a heatmap, a bar chart, a histogram, etc.) Metrics are converted to events by converting the data points of the metrics as events (e.g., one event per point). Metrics are converted to spans by interpreting each data point's value as a duration.

The default view for histograms is a histogram view. In some embodiments, histograms are converted to a metrics view by automatically converting it to the median of the distribution of the metrics data. In some embodiments, the conversion can default the distribution to the mean, the p95, the p99, the number of samples, etc.) Histograms are converted to events in a similar fashion as metrics, by converting the event to the median of the distribution of the event data. Histograms are converted to spans by interpreting the histogram as a distribution (e.g., a distribution of latencies).

The default view for events is an events view. In some embodiments, events are converted to a metrics view by displaying, for instance, as a time series of ongoing events at the start on every event and end (so the time series can climb up and come back down). Events can also be shown as durations at the start or end of an event, or as keywords that are extracted from the event. Events are converted to histograms generating buckets at pre-set intervals and allocating the events to the buckets according to the duration of the events. Events are converted to spans by interpreting the events as spans.

The default view for spans is a spans view. In some embodiments, spans are similar to events, and can be converted similarly. Spans can be converted to metrics by rendering the number of ongoing spans over time. Traces can be converted in similar ways. Spans can be converted to histogram as latencies bucketed by time buckets. Traces can be converted also in similar ways. Spans are converted to events by interpreting the spans as events.

In accordance with embodiments, query 202 includes visualization view 305 for automatically converting the underlying atom by applying the transforms described above. For example, the query can include spans( ) or traces ( ) within query 202. Visualizer 210 provides the query results visualization 220 at query node 104 for adapting the data stream into the intended output format.

Hence, the embodiments of the present invention greatly extend beyond conventional methods of visualizing query results of time series data. For instance, automatic conversion of an underlying atom to a visualization view improves the performance of querying of the data by providing the generation of synthetic data based on a visualization view of a query. For instance, upon query, the query results can be provided in a view associated with a different data type than the underlying data, allowing for enhanced querying, without requiring a user performing or controlling execution of the visualization conversion. Accordingly, embodiments of the present invention amount to significantly more than merely using a computer to visualize query results to time series data. Instead, embodiments of the present invention specifically recite a novel process, rooted in computer technology, for automatically converting query results to a different atom, improving performance of query processing in a time series data monitoring system.

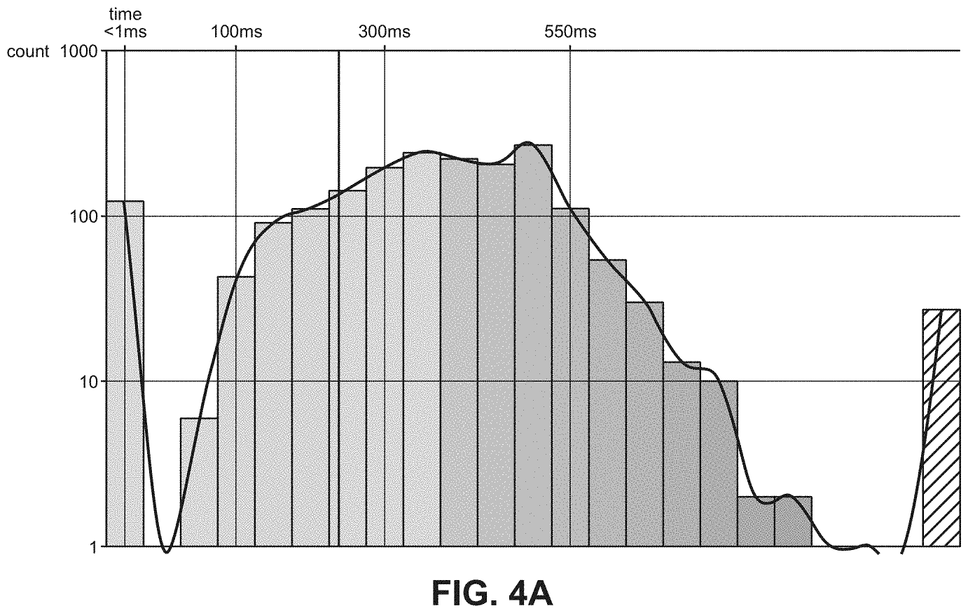

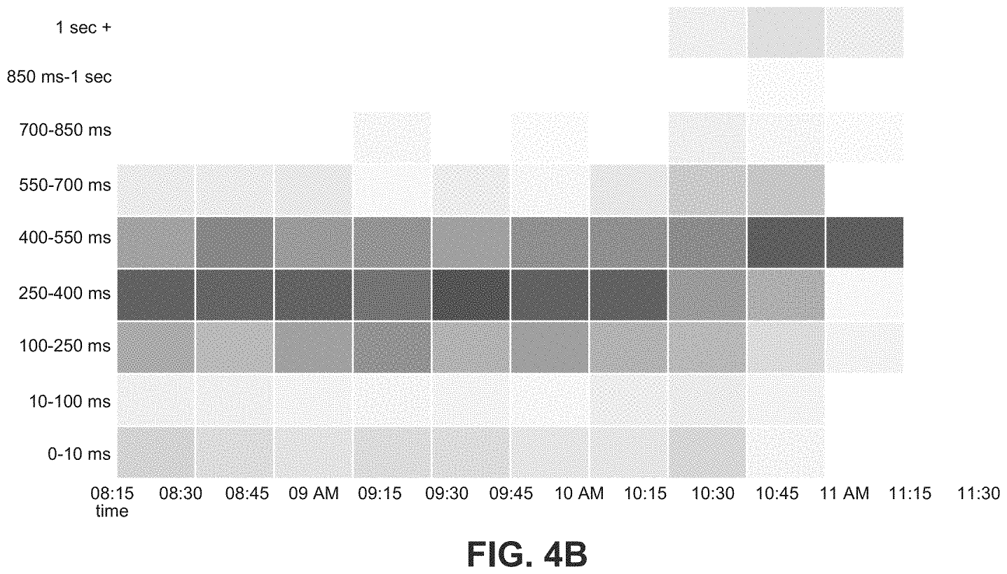

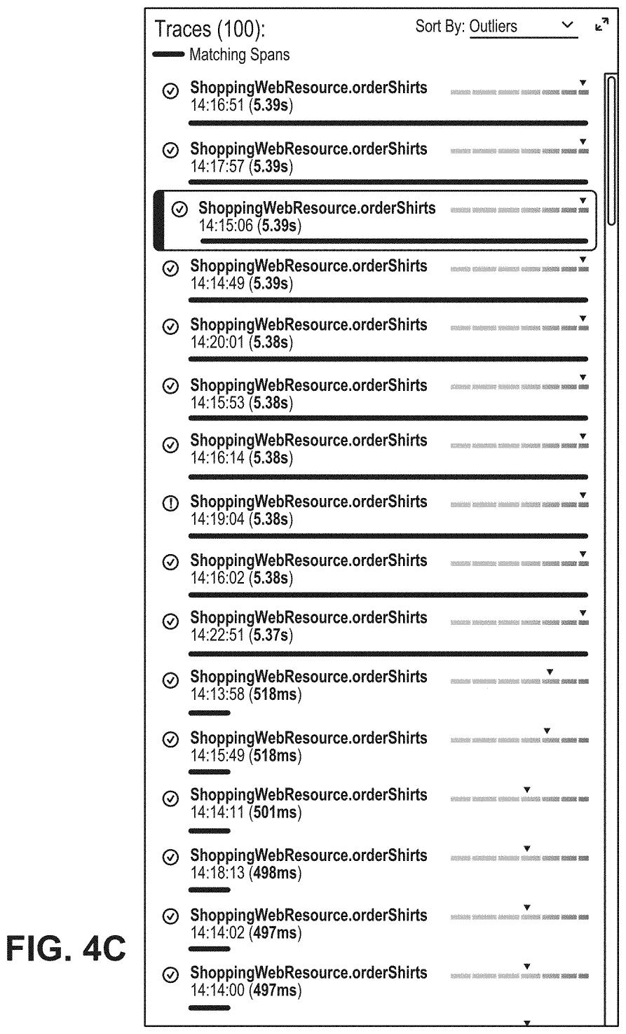

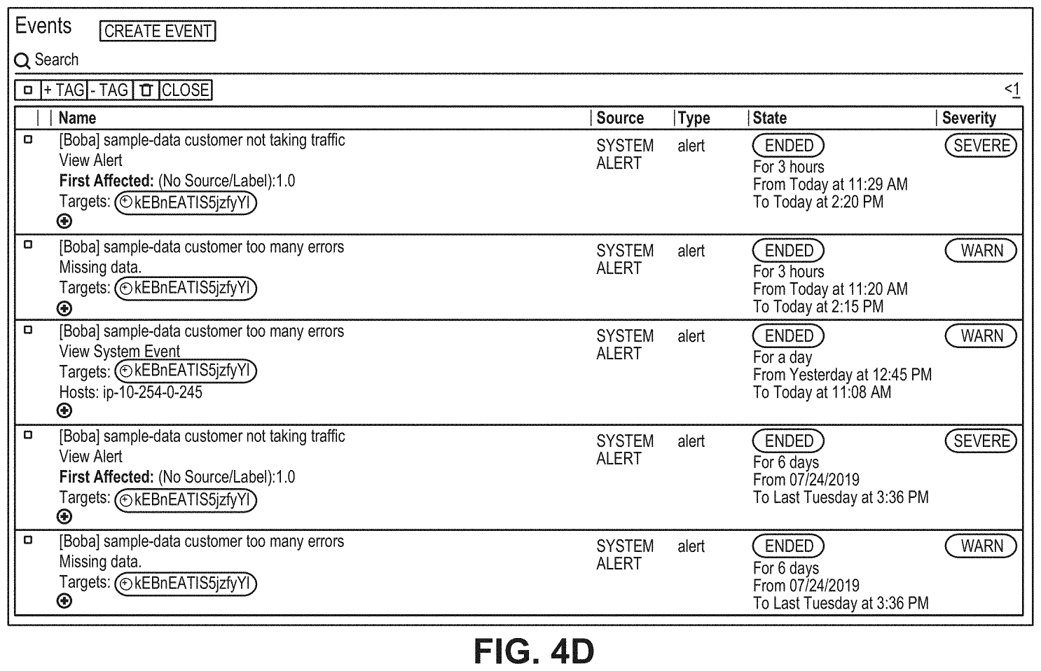

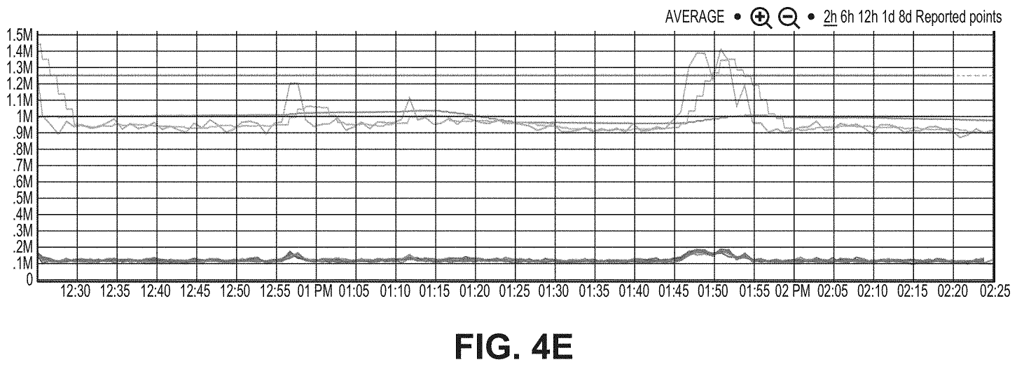

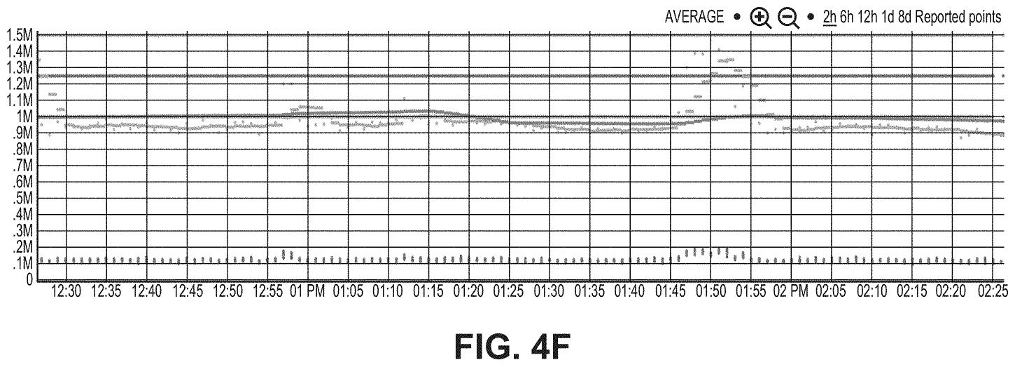

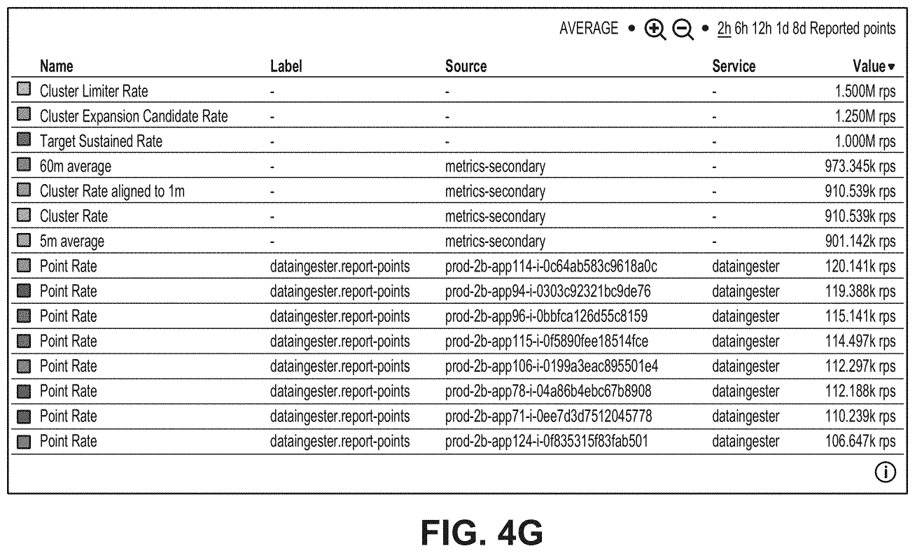

FIGS. 4A-4G depict example screenshots of various visualizations, in accordance with embodiments. Specifically, FIGS. 4A and 4B illustrate two example visualizations of histogram views, FIG. 4C illustrates an example visualization of a span/trace view, FIG. 4D illustrates an example visualization of an event view, FIG. 4E illustrates an example visualization of a time series view (a line chart), FIG. 4F illustrates an example visualization of a time series view (a point plot), and FIG. 4G illustrates an example visualization of a time series view (table).

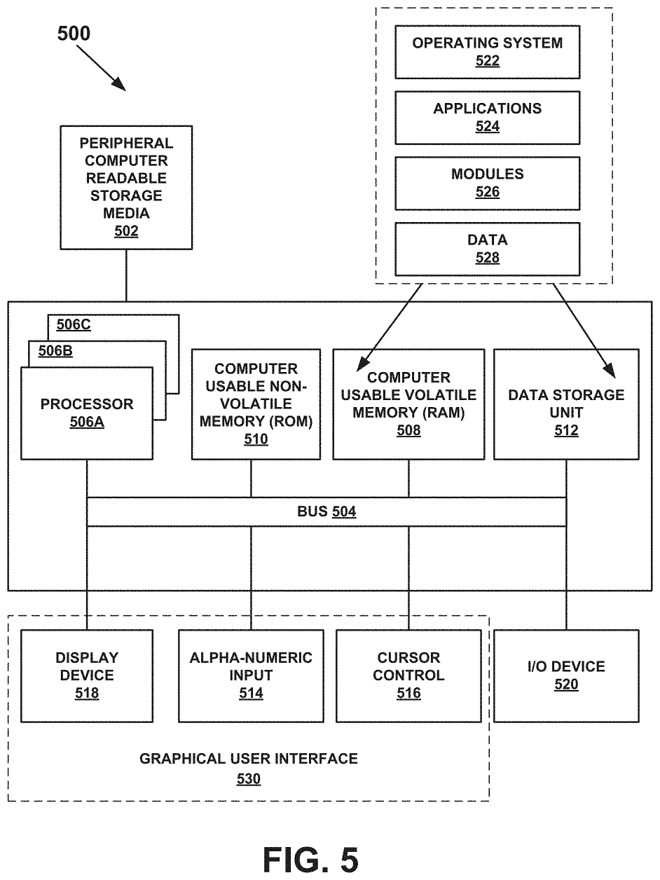

FIG. 5 is a block diagram of an example computer system 500 upon which embodiments of the present invention can be implemented. FIG. 5 illustrates one example of a type of computer system 500 (e.g., a computer system) that can be used in accordance with or to implement various embodiments which are discussed herein.

It is appreciated that computer system 500 of FIG. 5 is only an example and that embodiments as described herein can operate on or within a number of different computer systems including, but not limited to, general purpose networked computer systems, embedded computer systems, mobile electronic devices, smart phones, server devices, client devices, various intermediate devices/nodes, standalone computer systems, media centers, handheld computer systems, multi-media devices, and the like. In some embodiments, computer system 500 of FIG. 5 is well adapted to having peripheral tangible computer-readable storage media 502 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

Computer system 500 of FIG. 5 includes an address/data bus 504 for communicating information, and a processor 506A coupled with bus 504 for processing information and instructions. As depicted in FIG. 5, computer system 500 is also well suited to a multi-processor environment in which a plurality of processors 506A, 506B, and 506C are present. Conversely, computer system 500 is also well suited to having a single processor such as, for example, processor 506A. Processors 506A, 506B, and 506C may be any of various types of microprocessors. Computer system 500 also includes data storage features such as a computer usable volatile memory 508, e.g., random access memory (RAM), coupled with bus 504 for storing information and instructions for processors 506A, 506B, and 506C. Computer system 500 also includes computer usable non-volatile memory 510, e.g., read only memory (ROM), coupled with bus 504 for storing static information and instructions for processors 506A, 506B, and 506C. Also present in computer system 500 is a data storage unit 512 (e.g., a magnetic or optical disc and disc drive) coupled with bus 504 for storing information and instructions. Computer system 500 also includes an alphanumeric input device 514 including alphanumeric and function keys coupled with bus 504 for communicating information and command selections to processor 506A or processors 506A, 506B, and 506C. Computer system 500 also includes a cursor control device 516 coupled with bus 504 for communicating user input information and command selections to processor 506A or processors 506A, 506B, and 506C. In one embodiment, computer system 500 also includes a display device 518 coupled with bus 504 for displaying information.

Referring still to FIG. 5, display device 518 of FIG. 5 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 516 allows the computer user to dynamically signal the movement of a visible symbol (cursor) on a display screen of display device 518 and indicate user selections of selectable items displayed on display device 518. Many implementations of cursor control device 516 are known in the art including a trackball, mouse, touch pad, touch screen, joystick or special keys on alphanumeric input device 514 capable of signaling movement of a given direction or manner of displacement. Alternatively, it will be appreciated that a cursor can be directed and/or activated via input from alphanumeric input device 514 using special keys and key sequence commands. Computer system 500 is also well suited to having a cursor directed by other means such as, for example, voice commands. In various embodiments, alphanumeric input device 514, cursor control device 516, and display device 518, or any combination thereof (e.g., user interface selection devices), may collectively operate to provide a graphical user interface (GUI) 530 under the direction of a processor (e.g., processor 506A or processors 506A, 506B, and 506C). GUI 530 allows user to interact with computer system 500 through graphical representations presented on display device 518 by interacting with alphanumeric input device 514 and/or cursor control device 516.

Computer system 500 also includes an I/O device 520 for coupling computer system 500 with external entities. For example, in one embodiment, I/O device 520 is a modem for enabling wired or wireless communications between computer system 500 and an external network such as, but not limited to, the Internet. In one embodiment, I/O device 520 includes a transmitter. Computer system 500 may communicate with a network by transmitting data via I/O device 520.

Referring still to FIG. 5, various other components are depicted for computer system 500. Specifically, when present, an operating system 522, applications 524, modules 526, and data 528 are shown as typically residing in one or some combination of computer usable volatile memory 508 (e.g., RAM), computer usable non-volatile memory 510 (e.g., ROM), and data storage unit 512. In some embodiments, all or portions of various embodiments described herein are stored, for example, as an application 524 and/or module 526 in memory locations within RAM 508, computer-readable storage media within data storage unit 512, peripheral computer-readable storage media 502, and/or other tangible computer-readable storage media.

### Example Methods of Operation

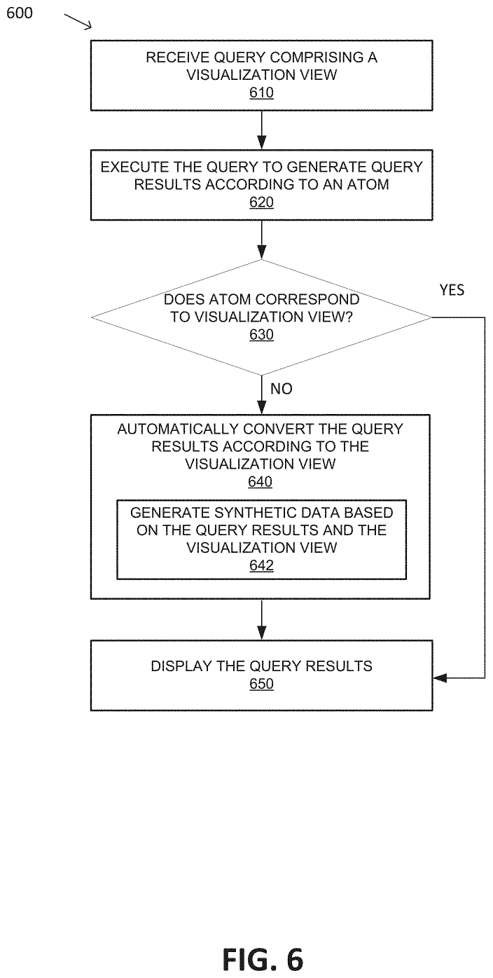

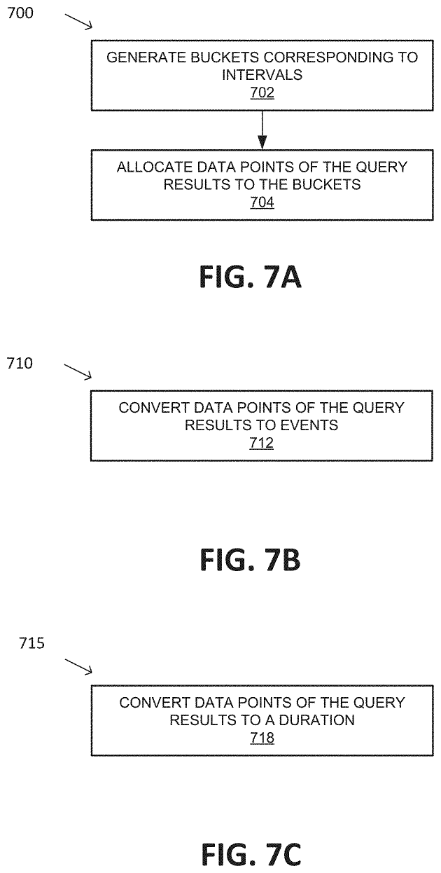

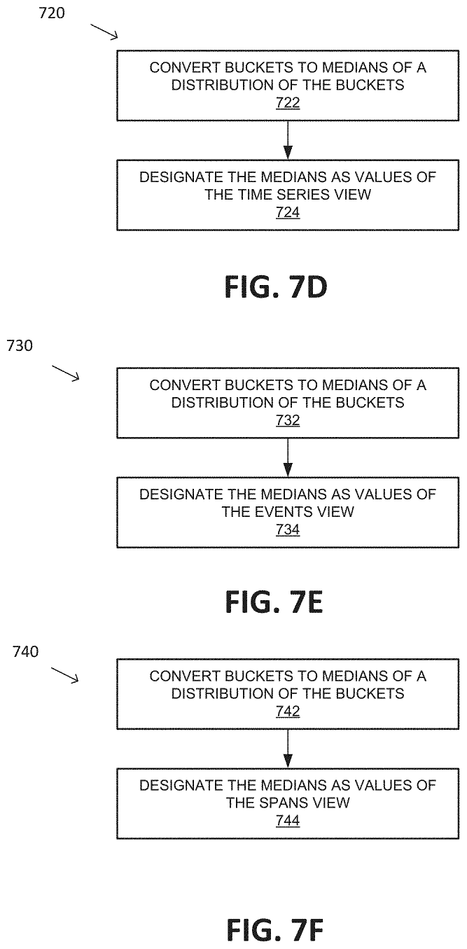

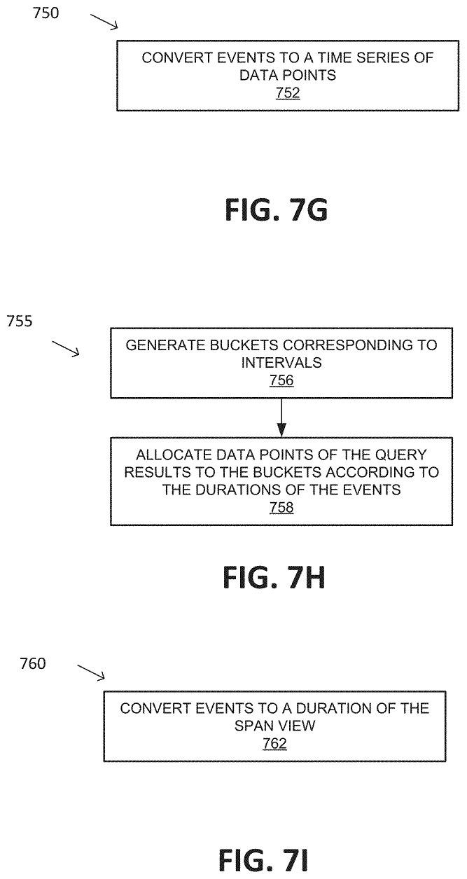

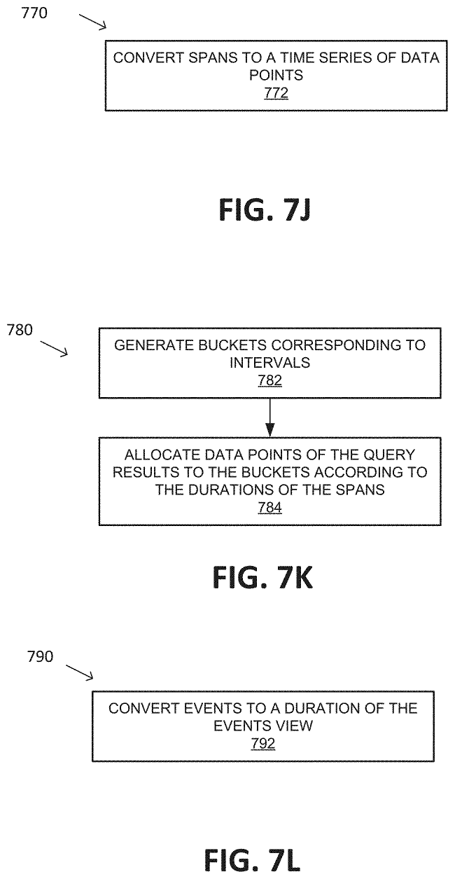

The following discussion sets forth in detail the operation of some example methods of operation of embodiments. With reference to FIGS. 6 through 7L, flow diagrams 600, 700, 710, 715, 720, 730, 740, 750, 755, 760, 770, 780, and 790 illustrate example procedures used by various embodiments. The flow diagrams include some procedures that, in various embodiments, are carried out by a processor under the control of computer-readable and computer-executable instructions. In this fashion, procedures described herein and in conjunction with the flow diagrams are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments (e.g., computer system 500). The computer-readable and computer-executable instructions, which reside on tangible computer readable storage media, are used to control or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in the flow diagram, such procedures are examples. That is, embodiments are well suited to performing various other procedures or variations of the procedures recited in the flow diagram. Likewise, in some embodiments, the procedures in the flow diagrams may be performed in an order different than presented and/or not all of the procedures described in the flow diagrams may be performed. It is further appreciated that procedures described in the flow diagrams may be implemented in hardware, or a combination of hardware with firmware and/or software provided by computer system 500.

FIG. 6 depicts a flow diagram 600 for visualization of a query result of time series data, according to an embodiment. At procedure 610 of flow diagram 600, a query of a time series database is received, the query comprising a time range, a predicate comprising at least one dimension, and a visualization view for displaying query results.

At procedure 620, the query is executed against the time series database to generate the query results according to an atom.

At procedure 630, it is determined whether the atom of the query results corresponds to the visualization view. In one embodiment, it is determined whether the visualization view is the default view for the query results. For example, the default view for metrics is time series data, the default view for histograms is a histogram view, the default view for events is an events view, and the default view for spans is a spans view. If it determined that the atom of the query results corresponds to the visualization view, flow diagram 600 proceeds to procedure 650.

If it determined that the atom of the query results does not correspond to the visualization view, flow diagram 600 proceeds to procedure 640. At procedure 640, the query results are automatically converted according to the visualization view of the query. In one embodiment, as shown at procedure 642, synthetic data based on the query results and the visualization view is generated, wherein the synthetic data is used for displaying the query results according to the visualization view.

In accordance with various embodiments, procedure 630 is performed according to the flow diagrams of FIGS. 7A-7L.

With reference to FIG. 7A, flow diagram 700 for converting the metrics atom to the histogram visualization view is illustrated, according to an embodiment. At procedure 702, buckets corresponding to intervals of values within the time range are generated. At procedure 704, data points of the query results are allocated to the buckets of the histogram view according to values of the query results.

With reference to FIG. 7B, flow diagram 710 for converting the metrics atom to the events visualization view is illustrated, according to an embodiment. At procedure 712, data points of the query results are converted to single events of the events view.

With reference to FIG. 7C, flow diagram 715 for converting the metrics atom to the spans visualization view is illustrated, according to an embodiment. At procedure 718, data points of the query results are converted to a duration of the spans view.

With reference to FIG. 7D, flow diagram 720 for converting the histograms atom to the time series visualization view is illustrated, according to an embodiment. At procedure 722, buckets of the histogram are converted to medians of a distribution of the buckets. At procedure 724, the medians are designated as values of the time series view.

With reference to FIG. 7E, flow diagram 730 for converting the histograms atom to the events visualization view is illustrated, according to an embodiment. At procedure 732, buckets of the histogram are converted to medians of a distribution of the buckets. At procedure 734, the medians are designated as values of the events view.

With reference to FIG. 7F, flow diagram 740 for converting the histograms atom to the spans visualization view is illustrated, according to an embodiment. At procedure 742, buckets of the histogram are converted to medians of a distribution of the buckets. At procedure 744, the medians are designated as values of the spans view.

With reference to FIG. 7G, flow diagram 750 for converting the events atom to the time series visualization view is illustrated, according to an embodiment. At procedure 752, the events are converted to a time series of data points at a start point and an end point of each event.

With reference to FIG. 7H, flow diagram 755 for converting the events atom to the histogram visualization view is illustrated, according to an embodiment. At procedure 756, buckets corresponding to intervals of values within the time range are generated. At procedure 758, data points of the query results are allocated to the buckets of the histogram view according to durations of the events corresponding to the data points.

With reference to FIG. 7I, flow diagram 760 for converting the events atom to the spans visualization view is illustrated, according to an embodiment. At procedure 762, data points of the query results are converted to a duration of the spans view according to durations of the events corresponding to the data points.

With reference to FIG. 7J, flow diagram 770 for converting the spans atom to the time series visualization view is illustrated, according to an embodiment. At procedure 772, the spans are converted to a time series of data points at a start point and an end point of each span.

With reference to FIG. 7K, flow diagram 780 for converting the spans atom to the histogram visualization view is illustrated, according to an embodiment. At procedure 782, buckets corresponding to intervals of values within the time range are generated. At procedure 784, data points of the query results are allocated to the buckets of the histogram view according to durations of the spans corresponding to the data points.

With reference to FIG. 7L, flow diagram 790 for converting the spans atom to the events visualization view is illustrated, according to an embodiment. At procedure 792, data points of the query results are converted to a duration of the events view according to durations of the spans corresponding to the data points.

With reference to FIG. 6, at procedure 650, the query results are displayed.

It is noted that any of the procedures, stated above, regarding the flow diagrams of FIGS. 6 through 7L may be implemented in hardware, or a combination of hardware with firmware and/or software. For example, any of the procedures are implemented by a processor(s) of a cloud environment and/or a computing environment.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Many variations, modifications, additions, and improvements are possible, regardless the degree of virtualization. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A computer-implemented method for visualization of a query result of time series data, the method comprising:
receiving a query of a time series database, the query comprising a time range, a predicate comprising at least one dimension, and a visualization view for displaying query results;
executing the query against the time series database to generate the query results according to an atom;
provided the atom does not correspond to the visualization view of the query, automatically converting the query results according to the visualization view; and
displaying the query results according to the visualization view of the query.

2. The method of claim 1, wherein the automatically converting the query results according to the visualization view of the query comprises:
generating synthetic data based on the query results and the visualization view, wherein the synthetic data is used for displaying the query results according to the visualization view.

3. The method of claim 1, wherein the atom is metrics and the visualization view is a histogram view, the automatically converting the query results according to the visualization view comprising:
generating buckets corresponding to intervals of values within the time range; and
allocating data points of the query results to the buckets of the histogram view according to values of the query results.

4. The method of claim 1, wherein the atom is metrics and the visualization view is an events view, the automatically converting the query results according to the visualization view comprising:
converting data points of the query results to single events of the events view.

5. The method of claim 1, wherein the atom is metrics and the visualization view is a spans view, the automatically converting the query results according to the visualization view comprising:
converting data points of the query results to a duration of the spans view.

6. The method of claim 1, wherein the atom is a histogram and the visualization view is a time series view, the automatically converting the query results according to the visualization view comprising:
converting buckets of the histogram to medians of a distribution of the buckets; and
designating the medians as values of the time series view.

7. The method of claim 1, wherein the atom is a histogram and the visualization view is an events view, the automatically converting the query results according to the visualization view comprising:
converting buckets of the histogram to medians of a distribution of the buckets; and
designating the medians as values of the events view.

8. The method of claim 1, wherein the atom is a histogram and the visualization view is a spans view, the automatically converting the query results according to the visualization view comprising:
converting buckets of the histogram to medians of a distribution of the buckets; and
designating the medians as values of the spans view.

9. The method of claim 1, wherein the atom is events and the visualization view is a time series view, the automatically converting the query results according to the visualization view comprising:
converting the events to a time series of data points at a start point and an end point of each event.

10. The method of claim 1, wherein the atom is events and the visualization view is a histogram view, the automatically converting the query results according to the visualization view comprising:
generating buckets corresponding to intervals of values within the time range; and
allocating data points of the query results to the buckets of the histogram view according to durations of the events corresponding to the data points.

11. The method of claim 1, wherein the atom is events and the visualization view is a spans view, the automatically converting the query results according to the visualization view comprising:
converting data points of the query results to a duration of the spans view according to durations of the events corresponding to the data points.

12. The method of claim 1, wherein the atom is spans and the visualization view is a time series view, the automatically converting the query results according to the visualization view comprising:
converting the spans to a time series of data points at a start point and an end point of each span.

13. The method of claim 1, wherein the atom is spans and the visualization view is a histogram view, the automatically converting the query results according to the visualization view comprising:
generating buckets corresponding to intervals of values within the time range; and
allocating data points of the query results to the buckets of the histogram view according to durations of the spans corresponding to the data points.

14. The method of claim 1, wherein the atom is spans and the visualization view is an events view, the automatically converting the query results according to the visualization view comprising:
converting data points of the query results to a duration of the events view according to durations of the spans corresponding to the data points.

15. A non-transitory computer readable storage medium having computer readable program code stored thereon for causing a computer system to perform a method for visualization of a query result of time series data, the method comprising:
receiving a query of a time series database, the query comprising a time range, a predicate comprising at least one dimension, and a visualization view for displaying query results;
executing the query against the time series database to generate the query results according to an atom;
provided the atom does not correspond to the visualization view of the query, automatically converting the query results according to the visualization view; and
displaying the query results according to the visualization view of the query.

16. The non-transitory computer readable storage medium of claim 15, wherein the automatically converting the query results according to the visualization view of the query comprises:
generating synthetic data based on the query results and the visualization view, wherein the synthetic data is used for displaying the query results according to the visualization view.

17. The non-transitory computer readable storage medium of claim 15, wherein the atom is selected from one of: metrics, histogram, events, and spans, and wherein the visualization view is selected from one of: a metric view, a histogram view, an events view, and a spans view.

18. A system for visualization of a query result of time series data, the system comprising:
a plurality of query nodes, each query node of the plurality of query nodes comprising a data storage unit and a processor communicatively coupled with the data storage unit, wherein a query node of the plurality of query nodes is configured to:
receive a query of a time series database, the query comprising a time range, a predicate comprising at least one dimension, and a visualization view for displaying query results;
execute the query against the time series database to generate the query results according to an atom;
automatically convert the query results according to the visualization view provided the atom does not correspond to the visualization view of the query; and
display the query results according to the visualization view of the query.

19. The system of claim 18, wherein the query node of the plurality of query nodes is further configured to:
generate synthetic data based on the query results and the visualization view, wherein the synthetic data is used for displaying the query results according to the visualization view.

20. The system of claim 18, wherein the atom is selected from one of: metrics, histogram, events, and spans, and wherein the visualization view is selected from one of: a metric view, a histogram view, an events view, and a spans view.
